(19) United States
(12) Patent Application Publication
(10) Pub. No.: US 2017/0024456 A1
(43) Pub. Date: Jan. 26, 2017

(54) METHOD AND APPARATUS FOR PROVIDING DOCUMENTS REFLECTING USER PATTERN

(71) Applicant: SAMSUNG SDS CO., LTD., Seoul (KR)

(72) Inventors: Jae-Young LEE, Seoul (KR); Jong-Sik PARK, Seoul (KR); Seong-Jun WON, Seoul (KR); Chul-Hong PARK, Seoul (KR)

(73) Assignee: SAMSUNG SDS CO., LTD., Seoul (KR)

(21) Appl. No.: 15/067,946

(22) Filed: Mar. 11, 2016

(30) Foreign Application Priority Data
Jul. 24, 2015 (KR) 10-2015-0105098

(51) Int. Cl. G06F 17/30; H04L 29/08; H04L 12/58

(52) U.S. Cl. CPC G06F 17/30598; G06F 17/3053; H04L 51/12; H04L 51/22; H04L 51/26; H04L 51/24; H04L 67/22

(57) ABSTRACT

A method of providing documents based on a use pattern includes configuring a cluster by clustering a plurality of documents; calculating a cluster importance of the cluster based on information of the cluster; calculating a user interest of the cluster based on a use pattern of a user with respect to the cluster; calculating a document importance of a respective document that belongs to the cluster based on information of the respective document; calculating a user interest of the respective document that belongs to the cluster based on the use pattern of the user with respect to the respective document; and providing the respective document using the cluster importance of the cluster, the user interest of the cluster, the document importance of the respective document, and the user interest of the respective document.

### CROSS-REFERENCE TO RELATED APPLICATION

This application claims priority from Korean Patent Application No. 10-2015-0105098, filed on Jul. 24, 2015, in the Korean Intellectual Property Office, the disclosure of which is incorporated herein in its entirety by reference.

### BACKGROUND

1. Field

The present invention relates to a method and an apparatus for providing documents reflecting a user pattern. More particularly, the present invention relates to a method and an apparatus for providing documents reflecting a user pattern, which can preferentially provide documents in which a user is more interested through numeralization of user interest in the documents.

2. Description of the Prior Art

With the development of computer and Internet technology, production and distribution of information have been accelerated. However, time required for a person to accommodate such information is limited to 24 hours in all ages, and thus selection of such information has become important as time goes by.

A person who receives several hundreds of mails even in a day is immensely worried about which mail he/she should first read. To cope with this, several mail folders may be made, and mail rules may be set to automatically classify mails into the respective mail folders. However, it is quite troublesome to make new mail folders and to set new rules one by one whenever a new project starts or a new customer is created.

In addition to such mails, a person who gets to the office should confirm official announcements that come up on a company bulletin board, documents for approval that come up on groupware, and messages of a company messenger that are sent from managers who always demand urgent replies to the messages. As a result, it may take a whole day for the person to read all the documents.

### SUMMARY

Accordingly, the present invention has been made to solve the above-mentioned problems occurring in the related art, and one subject to be solved by the present invention is to provide a method and an apparatus for providing documents reflecting a user pattern.

Additional advantages, subjects, and features of the invention will be set forth in part in the description which follows and in part will become apparent to those having ordinary skill in the art upon examination of the following or may be learned from practice of the invention.

According to the present invention as described above, since clusters are configured by clustering documents, related documents can be automatically confirmed. In addition, various kinds of documents through various channels can be confirmed at a time.

A user can be notified of a more important cluster through numeralization of priorities of respective clusters, and can also be notified of a more important document through numeralization of priorities of respective documents that belong to the corresponding cluster. In addition, user interest in the cluster and the documents that belong to the cluster can be continuously monitored through analysis of a user's use pattern, a proper countermeasure can be provided even if the user interest turns on other clusters and documents.

In an aspect of an exemplary embodiment, there is provided a method of providing documents based on a use pattern, the method including: configuring a cluster by clustering a plurality of documents; calculating a cluster importance of the cluster based on information of the cluster; calculating a user interest of the cluster based on a use pattern of a user with respect to the cluster; calculating a document importance of a respective document that belongs to the cluster based on information of the respective document; calculating a user interest of the respective document that belongs to the cluster based on the use pattern of the user with respect to the respective document; and providing the respective document using the cluster importance of the cluster, the user interest of the cluster, the document importance of the respective document, and the user interest of the respective document.

In an aspect of another exemplary embodiment, there is provided a method of providing documents based on a use pattern, the method including: calculating a document importance of a respective document among a plurality of documents; calculating a user interest of the respective document based on a use pattern of a user with respect to the respective document; clustering the plurality of documents using the user importance and the user interest of the respective document and configuring a cluster according to a result of the clustering; calculating a cluster importance of the cluster and a user interest of the cluster using the document importance and the user interest of a document that belongs to the cluster; and providing the document that belongs to the cluster, using the cluster importance and the user interest of the cluster and the document importance and the user interest of the document.

In an aspect of still another exemplary embodiment, there is provided an apparatus for providing documents based on a use pattern, the apparatus including: at least one processor; and a memory configured to load a computer program to be executed by the at least one processor, wherein the computer program, when executed by the at least one processor, causes the at least one processor to: configure a cluster by clustering of a plurality of documents; calculate a cluster importance of the cluster based on an information of the cluster; calculate a user interest of the cluster based on a use pattern of a user with respect to the cluster; calculate a document importance of a respective document that belongs to the cluster based on information of the respective document; calculate a user interest of the respective document that belongs to the cluster based on the use pattern of the user with respect to the respective document; and provide the respective document using the cluster importance of the cluster, the user interest of the cluster, the document importance of the respective document, and the user interest of the respective document.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram explaining providing of an intelligent view to a user by clustering documents and calculating importance and user interest in a cluster configured as the result of clustering and documents belonging to the cluster according to some embodiments of the present invention;

FIG. 2 is a flowchart of a method for providing documents reflecting a user pattern according to some embodiments of the present invention;

FIG. 3 is a diagram explaining calculation of importance of clusters according to some embodiments of the present invention;

FIG. 4 is a diagram explaining calculation of user interest in clusters according to some embodiments of the present invention;

FIG. 5 is a diagram explaining calculation of importance of documents belonging to a cluster according to some embodiments of the present invention;

FIG. 6 is a diagram explaining calculation of user interest in documents belonging to a cluster according to some embodiments of the present invention;

FIG. 7 is a diagram explaining calculation of priorities of clusters using importance and user interest in the clusters according to some embodiments of the present invention;

FIG. 8 is a diagram explaining calculation of priorities of documents belonging to a cluster using importance and user interest in the documents belonging to the cluster according to some embodiments of the present invention;

FIG. 9 is a diagram explaining calculation of importance and user interest in documents and clustering using the results of calculation according to some embodiments of the present invention;

FIG. 10 is a flowchart of a method for providing documents reflecting a user pattern according to some embodiments of the present invention;

FIG. 11 is an exemplary diagram of a graphic user interface for illustrating and providing clusters on a cluster priority coordinate plane having Y-axis representing cluster importance and X-axis representing user interest according to some embodiments of the present invention;

FIGS. 12 and 13 are exemplary diagrams of a graphic user interface for providing clusters and documents belonging to the clusters to a user using priorities of the clusters and priorities of the documents belonging to the clusters according to some embodiments of the present invention; and

FIG. 14 is a diagram of a hardware configuration of an apparatus for providing documents reflecting a user pattern according to some embodiments of the present invention.

### DETAILED DESCRIPTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, preferred embodiments of the present invention will be described in detail with reference to the accompanying drawings.

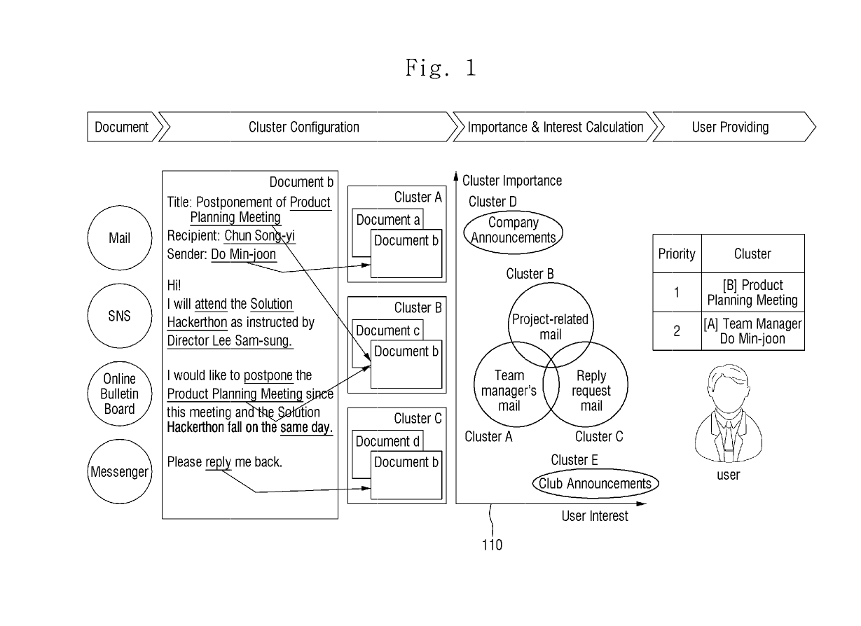

FIG. 1 is a diagram explaining providing of an intelligent view to a user by clustering documents and calculating importance and user interest in a cluster configured as the result of clustering and documents belonging to the cluster according to some embodiments of the present invention.

As illustrated in FIG. 1, various kinds of documents may exist through various channels. Writings that are sent and received through a mail, SNS, online bulletin board, and messenger are documents that will constitute a cluster. Of course, such documents may be individually read and confirmed through the respective channels. However, if the documents can be gathered and seen at a time, and further associated documents can be gathered seen at a time, a user could read and confirm the documents more easily and conveniently.

Technology to configure a cluster through clustering of a plurality of documents corresponds to a field which is called text mining and for which many research have been made together with natural language processing. Most text mining methods extract meaningful words from texts around main parts of speech through a preprocessing procedure, and perform clustering of the documents using similarity of the extracted keywords.

FIG. 1 simply illustrates a process of clustering document b that is classified as a mail. Main words are extracted from the title, recipient, sender, and text of the document b, and a cluster is configured based on the extracted words. For example, cluster A is a cluster that is composed of documents of which a preparer is “Do Min-joon”. Cluster B is a cluster that is composed of documents having a keyword “Product planning meeting”. Cluster C is a cluster that is composed of documents having a keyword “Reply”+“Request”.

FIG. 1 exemplifies that a cluster is configured simply based on the preparer of the documents and keywords. However, the cluster configuration is not limited thereto. In the case where the document is a mail, the cluster may be configured on the basis of the name of the recipient, on the basis of whether the user has received the mail as a recipient or a reference, or on the basis of preparation date of the documents. Further, the cluster may also be configured on the basis of a plurality of keywords rather than one keyword. Further, the respective documents may belong to only one cluster, or like the document b, the documents may simultaneously belong to several clusters.

As described above, if the cluster is configured through clustering of the plurality of documents and the documents are provided to a user, a new cluster is automatically created even if a new project starts or a new customer is created, and thus user's inconvenience that is caused by making of a new mail folder and setting of a new rule can be reduced.

If several clusters are configured through clustering of the documents, it becomes necessary to set priorities of the respective clusters. In order to determine the priorities, two factors may be considered. One is a user independent priority, and the other is user dependent priority. Hereinafter, the user independent priority is called cluster importance or document importance, and the user dependent priority is called user interest in a cluster or user interest in a document. The cluster priority may be determined using the cluster importance and the user interest in the cluster, and the document priority may be determined using the document importance and the user interest in the document.

The cluster importance and the document importance are priorities that are dependent to the user independent cluster or document, and thus if the clusters or documents are the same, they have the same value even in the case of different users. However, the user interest in the cluster and the user interest in the document are the user dependent priorities, and thus even in the case of the same clusters or documents, they have different values by users. That is, if the importance is an objective priority, the interest may be a subjective priority. If the priorities of the clusters and documents are determined in consideration of these two factors, it becomes possible to preferentially provide generally important clusters and documents in a user custom-made manner.

FIG. 1 exemplifies cluster D of “Company official announcement” having high cluster importance and low user interest, and cluster E of “Club official announcement” having low cluster importance and high user interest. Further, clusters A, B, and C to which the document b belongs occupy specific areas in accordance with the cluster importance and the user interest. Since the respective clusters are not in an exclusive relationship, an intersection may exist, and the document b may exist in an intersection area of the clusters A, B, and C.

On a cluster priority coordinate plane 110 having one axis representing the cluster importance and the other axis representing user interest, the cluster has lower priority as going closer to the original point, and the cluster has higher priority as going farther from the original point. By numeralizaing the priority of the cluster and providing documents to the user based on the numeralized priority as described above, a user can preferentially confirm only important documents.

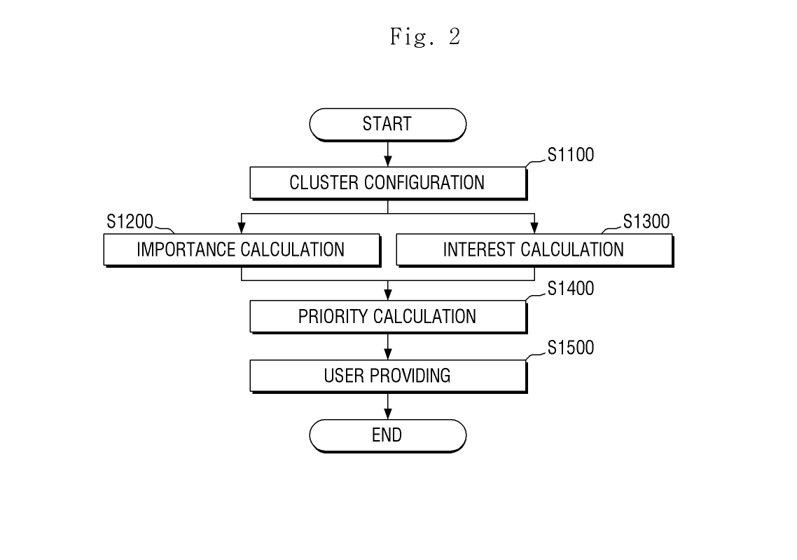

FIG. 2 is a flowchart of a method for providing documents reflecting a user pattern according to some embodiments of the present invention.

First, a cluster is configured by clustering a plurality of documents (S1100).

Here, as the standard for clustering, a document preparer (or an entity that generates a document), preparation date (or a date on which the document is generated), whether the document has been read, and existence/nonexistence of accompanying files may be considered. That is, the cluster may be composed of only documents prepared by a specific preparer, and the cluster may be configured through division of the preparation date, such as documents prepared in a day, documents prepared in a week, documents prepared in a month, documents prepared in a year, and documents prepared in a further period. Further, the cluster may be composed of only documents that have not yet been read, or the cluster may be composed of only documents having accompanying files.

When a user confirms mails using mail programs, most mail programs basically provide several simple alignment standards. In the case of Microsoft Outlook, alignment standards, such as a sender, title, date of reception, and size, are basically provided. Even in the case of Naver web mails, the same alignment standards are basically provided. Most mail programs may basically provide similar alignment standards. Whenever the user selects the alignment standards as needed, mails of a mail box are aligned and shown in accordance with the selected alignment standards. However, even if the alignment standards are selected, it is unable to align and see documents received within an hour simultaneously with aligning and seeing mails sent by the manager. That is, it is unable to see the mail and the document at the same time through applying of two alignment standards with the same level. In this case, the mail and the document should be respectively selected to be seen to cause inconvenience in use. This is because the mails can be aligned only with one alignment standard. That is, if the alignment standards are applied only in one-dimensional manner, such inconvenience may be caused.

In contrast, according to some embodiments of the present invention, if respective clusters are configured on the basis of the preparer, preparation date, and whether the document is read and illustrated on the cluster priority coordinate plane 110, the distribution of the documents can be intuitively grasped. That is, documents which are sent by the manager and are received within an hour can be confirmed by selecting an intersection area of the cluster that is composed of only the documents sent by the manager and the cluster that is composed of only the documents received within an hour. As described above, by applying and illustrating various clustering standards on the cluster priority coordinate plane 110, a user can easily select and confirm desired documents in comparison to the existing one-dimensional alignment standard.

In addition to using of meta information of the above-described documents as the clustering basis, a text mining method using contents information of the document may be considered as another standard. That is, a cluster may be configured with only documents having similar contents based on similarity between documents after extracting keywords through analysis of texts of the documents and calculating similarity between the documents using the extracted keywords. Using the text mining method, a cluster can be automatically configured with a project name newly appearing on the mail or bulletin board as a keyword without the necessity of making a separate mail folder even if a new project starts.

According to an embodiment of the present invention, a subject word of a cluster may be derived using configuration standards of the cluster after the cluster is configured using the meta information and contents information of the documents. In the case of configuring the cluster based on the meta information of the documents, the respective pieces of meta information may become the subject words, and in the case of configuring the cluster based on the contents information of the documents, respective keywords may become the subject words. As exemplified in FIG. 1, the subject words of the cluster according to the respective cluster configuration standards, such as “Company official announcement”, “Club official announcement”, and “Manager Do Min-joon”. If such subject words are illustrated together instead of merely illustrating the cluster on the cluster priority coordinate plate 110 as an area, user convenience can be further heightened. In addition, even in the case of providing the cluster in the form of a list, the subject word of the cluster can be utilized.

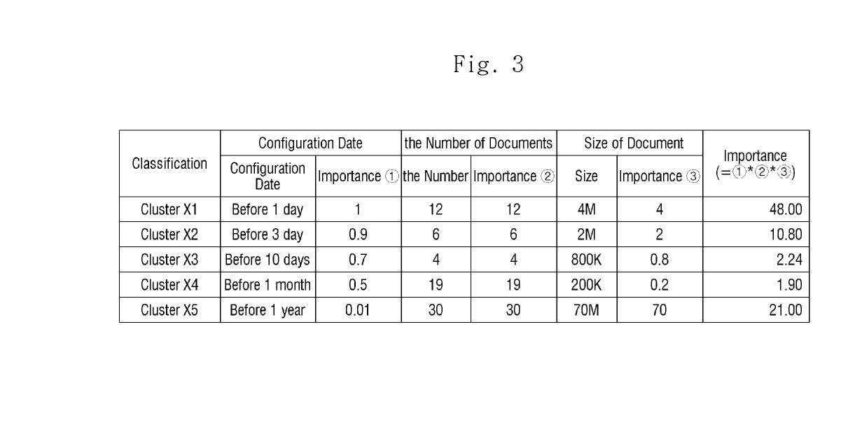

After configuring the cluster, importance calculation (S1200) and interest calculation (S1300) are performed. The cluster importance and the document importance may be calculated through analysis of the cluster meta information and the document meta information, and the user interest in the cluster and the user interest in the document may be calculated through analysis of a user's use pattern for the cluster and the document. This will be described in more detail with reference to FIGS. 3 to 6.

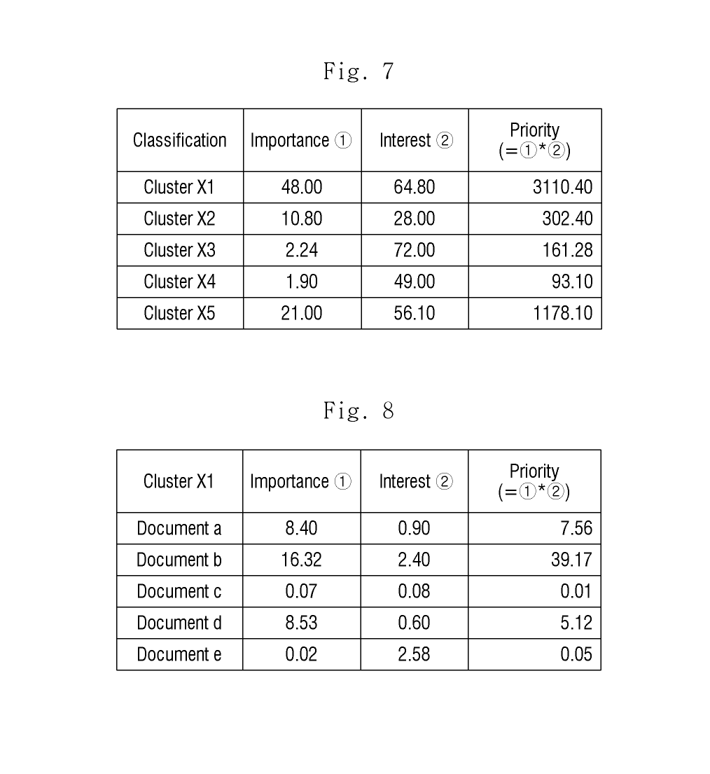

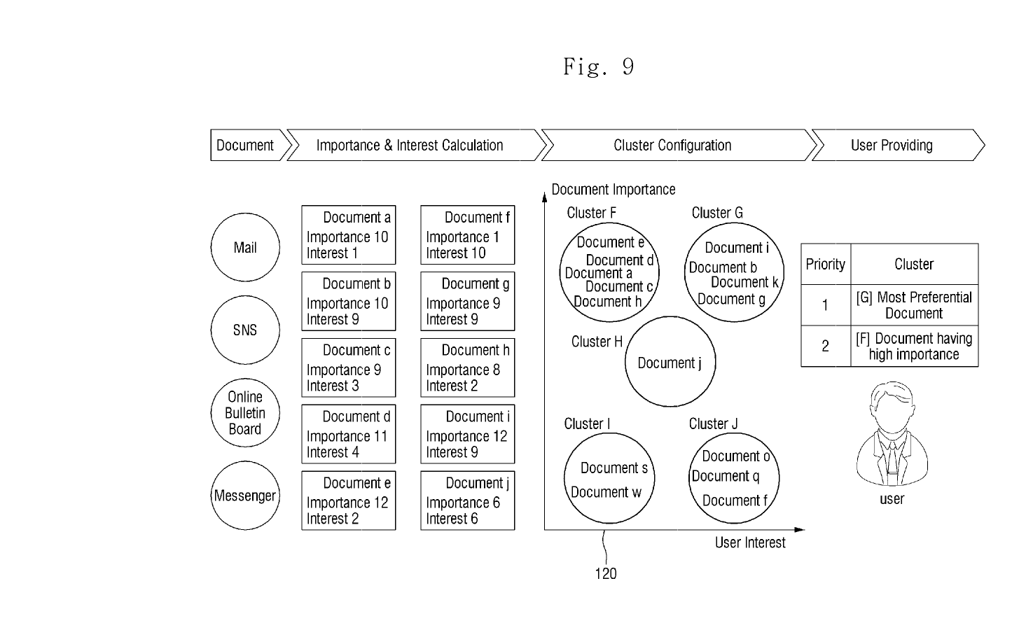

After the importance and the interest are calculated, the priority is calculated using the results of calculation (S1400). The cluster priority is calculated using the cluster importance and the user interest, and the document importance and the user interest in the document. This will be described in more detail with reference to FIGS. 7 and 8.

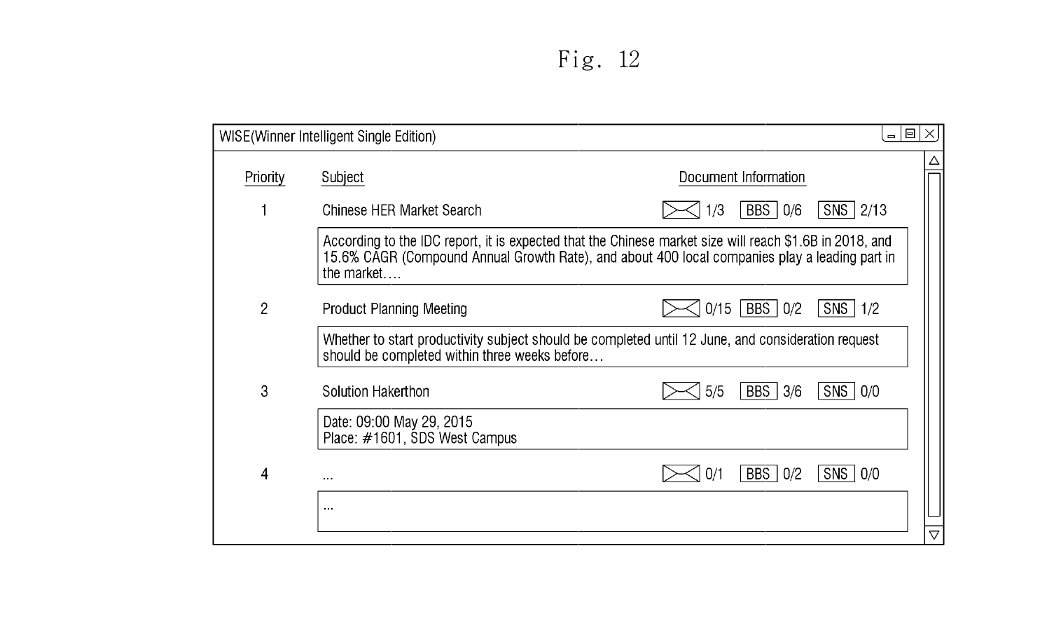

After the priority is calculated, the cluster and the documents are provided to the user using the result of the calculation (S1500). In the case of providing the cluster to the user using the priority, a graphic user interface using the cluster priority coordinate plane 110 and a graphic user interface in the form of a list that is aligned using the priority may be considered. This will be described in more detail with reference to FIGS. 11 to 13.

FIG. 3 is a diagram explaining calculation of importance of clusters according to some embodiments of the present invention.

In order to calculate the cluster importance, the cluster importance can be calculated using the meta information of the cluster itself that is not related to the user. In this case, as the usable meta information, date of the cluster configuration, the number of documents that belong to the cluster, and the sum of sizes of the documents that belong to the cluster may be considered. In general, the cluster configured long ago has low importance, the cluster has high importance as the number of documents that belong to the cluster becomes large, and the cluster has high importance as the sum of the sizes of the documents that belong to the cluster becomes large. Like the birth, growth, and extinction of a star through gathering of dust, the cluster importance may be evaluated through numeralization of the birth, growth, and extinction of a cluster through gathering of the cluster.

In the case of numeralizing the importance based on the date of the cluster configuration, the importance of the most recently configured cluster is set to 1, and the importance may be set to be exponentially decreased as time goes by. In the case of numeralizing the importance based on the number or size of documents that belong to a cluster, the importance may be allocated in arithmetical proportion to the number or size of the documents, or the importance may be allocated so as to be exponentially converged to a specific value. That is, in the case of the value that is decreased according to the standards, the importance may be allocated so as to be exponentially decreased to prevent the occurrence of a negative number. However, in the case of the value that is increased according to the standards, the importance may be allocated so as to be in arithmetic proportion to the number or size of the documents or to be exponentially converged to a specific value, which is a matter of choice. However, if the distribution of the values according to the standards is high, it is preferable that the importance is allocated so as to be exponentially converted to the specific value.

If the importance is allocated so as to be in arithmetical proportion to the number or size of the documents, it is preferable to calculate the cluster importance by multiplying the importance according to the respective standards when the cluster importance is calculated through synthesis of the respective standards later. If the importance is allocated to be converged to the specific value, this means that a kind of standardization process has been performed, and thus the cluster importance may be calculated through addition of the importance according to the respective standards.

In the example of FIG. 3, the importance is allocated in arithmetic proportion to the number or size of the documents that belong to the cluster. Further, in the case of calculating the cluster importance of the cluster, the cluster importance is numeralized through multiplication of the importance according to the respective standards. According to the example of FIG. 3, cluster X1 is a cluster that was configured before one day, and the corresponding importance is numeralized to “1”. Further, the number of documents that belong to X1 is “12” to make the corresponding importance numeralized to “12”, and the sum of the sizes of the documents that belong to X1 is 4M to make the corresponding importance numeralized to “4”. Through synthesis of these values, the cluster importance has the value of 1*12*4=48.00.

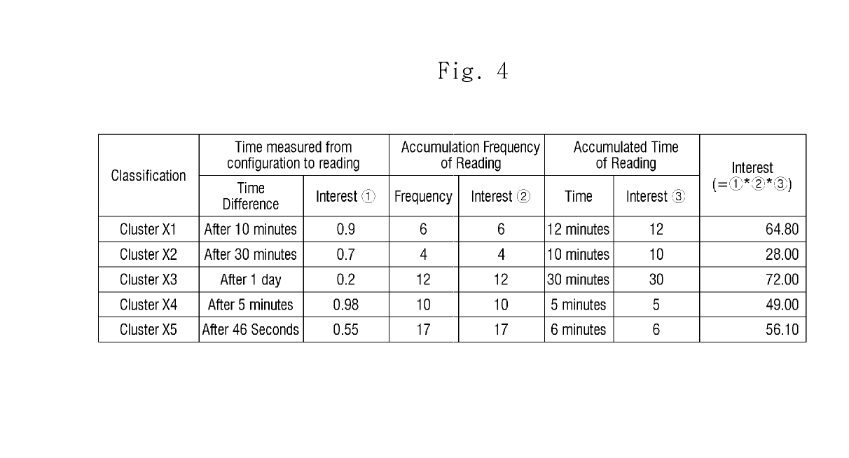

FIG. 4 is a diagram explaining calculation of user interest in clusters according to some embodiments of the present invention.

In order to calculate the user interest of the cluster, user dependent items should be standardized. Of course, since it is not possible to directly recognize human mind, the human interest may be indirectly numeralized in consideration of time that is the limited resource that a person has. That is, how much time the user spent for the specific cluster may be the standard of the interest. In this case, the time taken until the user reads the corresponding cluster after the cluster is configured with the user's use pattern, accumulation frequency of reading, and accumulated time of reading may be considered.

In the example of FIG. 4, in the same manner as the importance calculation, the importance is allocated so as to exponentially decrease according to the time taken until the user reads the corresponding cluster after the cluster is configured with the user's use pattern, and to be in arithmetic proportion to the accumulation frequency of reading and the accumulated time of reading. According to the example of FIG. 4, cluster X1 is a cluster which takes 10 minutes until the user reads the same after the cluster is configured, and the corresponding interest is numeralized to “0.9”. Further, the accumulation frequency of reading is “6” to make the corresponding interest numeralized to “6”, and the accumulated time of reading is 12 minutes to make the corresponding interest numeralized to “12”. Through synthesis of these values, the user interest has the value of 0.9*6*12=64.8.

Here, it may be important to use the accumulation frequency of reading and the accumulated time of reading as the user's use pattern. As a specific cluster is configured, and a new document is newly entered into the corresponding cluster to make the cluster grow, the accumulation frequency for the user to read the corresponding cluster and the accumulated time are also increased. If the project is ended or transaction with a customer is ended, the growth of the corresponding cluster stops, and the accumulation frequency for the user to read the corresponding cluster and the accumulated time also stop. Instead, the user's interest may be concentrated onto the cluster related to the new project or new customer, and the user interest can be reflected and calculated even if the user interest turns on other clusters and documents.

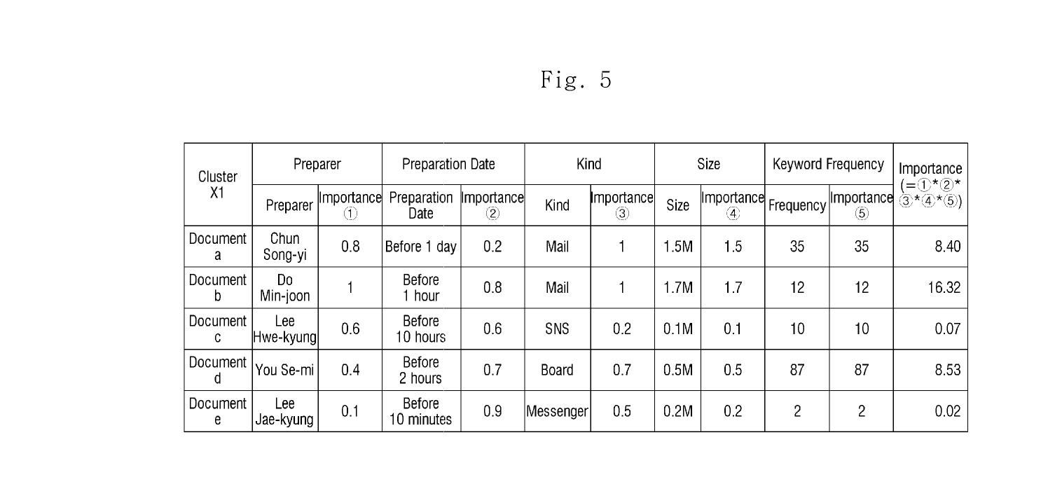

FIG. 5 is a diagram explaining calculation of importance of documents belonging to a cluster according to some embodiments of the present invention.

In the same manner as the cluster importance, meta information of the document may be used to calculate the document importance. In this case, as the meta information of the document that can be used, a document preparer, preparation date, kind, size, and keyword frequency (or frequency of appearance of a keyword) may be considered. Here, the importance according to the document preparer may be associated with a company job classification system and an organization system. This is because the importance of a mail written by a staff is different from the importance of a mail written by a manager or a president, and the importance of a mail written by the same team member is different from the importance of a mail written by a team member of another team. Further, the importance of the document becomes higher as the document is prepared at the latest, the size of the document becomes larger, or the frequency of keywords included in the text of the document becomes higher. Further, the importance according to the kind of the document may be allocated with an appropriate value in accordance with the characteristic of the channel through which the document is distributed. In the example of FIG. 5, the mail is allocated with the importance of “1”, the bulletin board is allocated with the importance of “0.7”, the messenger is allocated with the importance of “0.5”, and the SNS is allocated with the importance of “0.2”.

According to the example of FIG. 5, the preparer of document a that belongs to cluster X1 is “Chun Song-yi”, and the corresponding importance is numeralized to “0.8”. Further, the preparation date is before one day, and the corresponding importance is numeralized to “0.2”, and the kind of the document is a mail, and the corresponding importance is numeralized to “1”. Further, the size of the document is 1.5M, and the corresponding importance is numeralized to “1.5”, and the keyword frequency is “35”, and the corresponding importance is numeralized to “35”. Through synthesis of these values, the document importance has the value of 0.8*0.2*181.583.5=8.40.

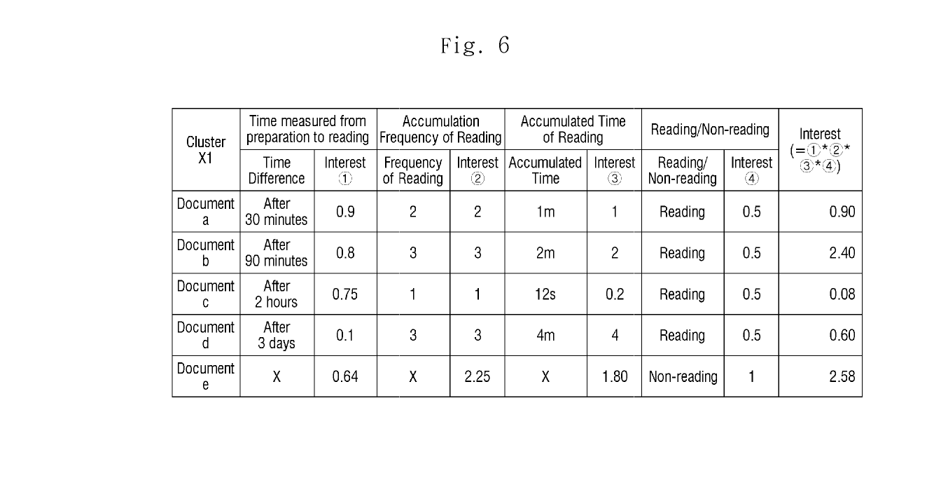

FIG. 6 is a diagram explaining calculation of user interest in documents belonging to a cluster according to some embodiments of the present invention.

In the same manner as the user interest of the cluster, the user's use pattern for the documents may be used to calculate the user interest of the documents. In this case, as the user's use pattern that can be used, time taken until the user reads the corresponding document after the document is prepared, accumulation frequency of reading, accumulated time of reading, and whether to read the document may be considered. Since the explanation of the time taken until the user reads the corresponding document after the document is prepared, the accumulation frequency of reading, and the accumulated time of reading is not greatly different from that of the above-described user interest of the cluster, the detailed explanation thereof will be omitted.

Generally, in the case of a document that a user has not yet read, the user should preferentially read and confirm the document, and thus high interest is allocated to the document in comparison to the read documents. In the example of FIG. 6, the read document is allocated with the interest of “0.5”, and the document that has not yet been read is allocated with the interest of “1”. In the example of FIG. 6, the importance is allocated to the read document and the non-read document in the ratio of 1:2. However, any other ratio may be applied in accordance with respective situations and in accordance with user's personal setting.

However, in the case where the user has not yet read the document, unlike the document that the user has already read, it is somewhat difficult to calculate the interest using the user's use pattern. That is, since it is not possible to apply the interest in consideration of the use pattern, such as the accumulation frequency of reading and the accumulated time of reading, to the document that the user has not yet read, it is necessary for the user to take great pains over the values to be used at that time. In this case, the user interest in the non-read document may be calculated on the basis of an average interest value of the documents which are read by the user and belong to the cluster including the corresponding non-read document. That is, if a similar keyword is used, in the same manner as the same preparer, since the cluster is a group of similar documents by means of the respective cluster configuration standards, the interest of the corresponding non-read document may be calculated using the average interest value of the read documents that belong to the cluster including the corresponding non-read document. In this case, it may be expected that the corresponding non-read document has the above-described interest value that can be expected in the case where the user reads the corresponding documents.

As described above, a specific document may belong to a plurality of clusters. If the cluster is composed of only the non-read documents, in the non-read document cluster, the expected interest values of the non-read documents, in spite of the non-read documents, can be calculated using the average interest value of other clusters to which the respective non-read documents belong, and using the calculated values, the non-read documents, in which the user may be interested, may be preferentially provided. As described above, by providing the expected custom-made use pattern reflecting the user's past use pattern, user convenience can be strengthened.

According to the example of FIG. 6, document a that belongs to cluster X1 is a document which takes 30 minutes until the user reads the same after the document a is prepared, and the corresponding interest is numeralized to “0.9”. Further, the accumulation frequency of reading is “2” to make the corresponding interest numeralized to “2”, the accumulated time of reading is 1 minute to make the corresponding interest numeralized to “1”, and as the read document, the corresponding interest is numeralized to “0.5”. Through synthesis of these values, the user interest has the value of 0.9*2*1*0.5=0.90. On the other hand, document e that belongs to cluster X1 is a document that the user has not yet read, and the corresponding interest is numeralized to “1”. In addition, the interest according to the time until the document is read after being prepared is numeralized to “0.64” that is an average interest value of the read documents that belong to X1, the interest according to the accumulation frequency of reading is numeralized to “2.25” that is an average interest value of the read documents that belong to X1, and the interest according to the accumulated time of reading is numeralized to “1.80” that is an average interest value of the read documents that belong to X1. Through synthesis of these values, the user interest has the expected interest value of 0.64*2.25*1.80*1=2.58.

FIG. 7 is a diagram explaining calculation of priorities of clusters using importance and user interest in the clusters according to some embodiments of the present invention.

Once the cluster importance and the user interest of the respective clusters are calculated, priorities of the clusters should be calculated using the results of the calculation. In the above-described example, a standardization process for making the calculated cluster importance and user interest converged to the specific values is not performed, and thus the priority is calculated by multiplying the importance and the interest by each other.

According to FIG. 7, the cluster X1 has the cluster importance of “48.00” and the user interest of “64.80”, and through synthesis of these values, the priority of the cluster X1 becomes “3110.40”. Using the same method, the priorities of other clusters may be calculated, and the cluster having the large priority value among the several clusters is preferentially provided to the user. Accordingly, the user can be less worried about which cluster he/she should first confirm.

FIG. 8 is a diagram explaining calculation of priorities of documents belonging to a cluster using importance and user interest in the documents belonging to the cluster according to some embodiments of the present invention.

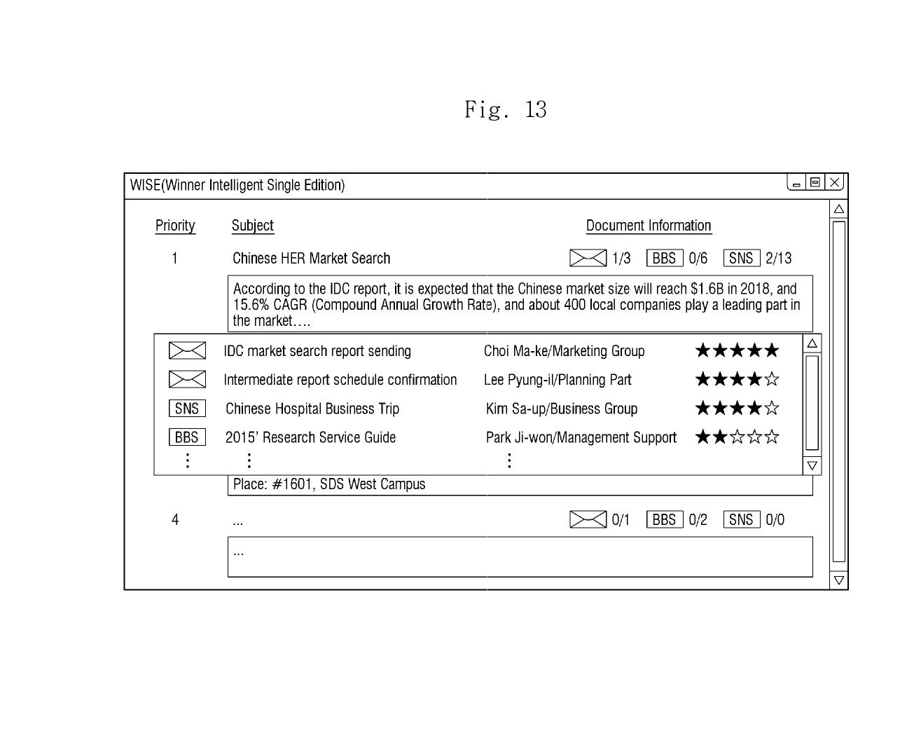

Since calculation of the priorities of the documents using the document importance and the user interest of the documents is not greatly different from the calculation of the priorities of the clusters of FIG. 7, the detailed explanation thereof will be omitted. If the priorities of the documents that belong to the cluster are calculated, summary information of the document having the highest priority among the documents that belong to the corresponding cluster can be shown together with the subject word of the cluster when the cluster is provided in the form of a list. In this case, even if the user does not read the corresponding cluster, the user can simply grasp the contents of the corresponding cluster through summary information from the cluster list. This will be described in more detail later with reference to FIGS. 12 and 13.

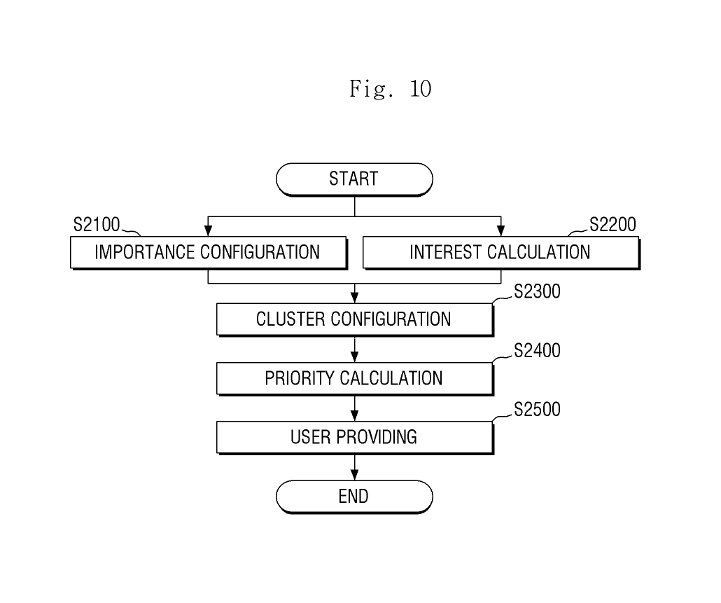

FIG. 9 is a diagram explaining calculation of importance and user interest in documents and clustering using the results of calculation according to some embodiments of the present invention.

Up to now, it is described that the cluster is first configured on the basis of the meta information (e.g., preparer) of the document and the contents information (e.g., keyword) of the document, and then the importance and the interest are calculated. However, it may also be considered that the document importance and the user interest of the documents may be first calculated, and then the clustering may be configured. That is, if the respective documents are illustrated on the document priority coordinate plane 120 after the document importance and the user interest of the documents are calculated according to the above-described standards, the respective documents may show uniform distribution, and the cluster can be configured using such distribution of the documents.

As illustrated in FIG. 9, clusters F to J may be configured by calculating the document importance and the user interest of document a to document j and illustrating the results of calculation on the document priority coordinate plane 120. Here, cluster G is a cluster composed of documents having high priorities, and cluster I is a cluster composed of documents having low priorities. Further, cluster F is a cluster composed of documents having high document importance, and cluster J is a cluster composed of documents having high user interest.

As described above, a meaningful cluster can be configured even if the document importance and the user interest of the document are first calculated and then the cluster is configured based on the results of the calculation. However, since the cluster configured as described above results from the clustering using the document importance and the user interest of the documents, it is more preferable that the document importance and the user interest of the corresponding cluster are calculated using the document importance and the user interest of the documents that belong to the corresponding cluster.

According to the example of FIG. 9, the cluster importance of the cluster F is calculated as the value of (10+9+11+12+8)/5=10 that is the average document importance of the documents a, c, d, e, and h that belong to the cluster F, and the user interest of the cluster F is calculated as the value of (1+3+4+2+2)/5=2.4 that is the average user interest of the documents a, c, d, e, and h that belong to the cluster F. That is, if the cluster is configured on the document priority coordinate plane 120, and the cluster importance and interest are determined using the average importance value and the average interest value of the documents that belong to the respective clusters, these values become values that indicate the center point of the corresponding cluster. That is, if it is assumed that the cluster F is a circle, coordinates (2.3, 10) of the center point of F become the user interest and the cluster importance of the cluster F.

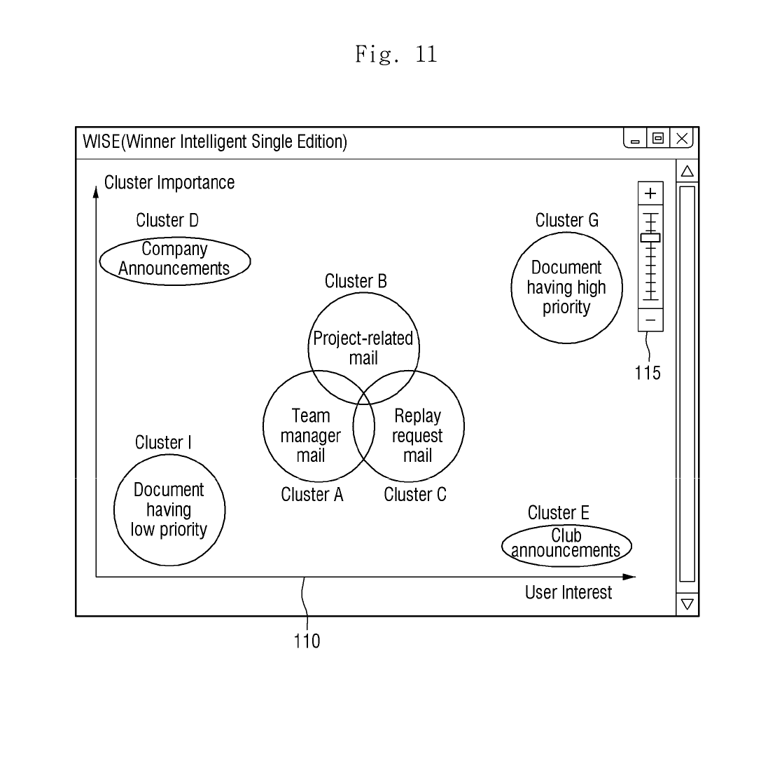

FIG. 10 is a flowchart of a method for providing documents reflecting a user pattern according to some embodiments of the present invention.

FIG. 10 illustrates an embodiment in which the document importance and the user interest of the document are first calculated, and then the cluster is configured on the basis of the results of the calculation. In FIG. 10, calculating of the importance (S2100) and calculating of the interest (S2200) are not greatly different from S1200 and S1300 of FIG. 2. In addition, calculating of the priorities (S2400) and providing of the results of calculation to the user (S2500) are similar to those as illustrated in FIG. 2. However, only configuring of the cluster (S2300) has the characteristic as described above with reference to FIG. 9. That is, according to the present invention, as the standards for configuring the cluster, document priority information may be used in addition to the meta information of the document and the contents information of the document. As the cluster is configured with various standards, various points of view can be provided to the user.

FIG. 11 is an exemplary diagram of a graphic user interface for illustrating and providing clusters on a cluster priority coordinate plane having Y-axis representing cluster importance and X-axis representing user interest according to some embodiments of the present invention.

FIG. 11 exemplifies that respective clusters are illustrated on a cluster priority coordinate plane 110 based on the importance and the interest of the clusters to be provided to the user on a screen. According to this embodiment, it becomes possible to intuitively grasp the distribution of the clusters as compared with the basic screen on which clusters are simply aligned according to their priorities and are provided in the form of a list. On the cluster priority coordinate plane 110, the respective clusters are illustrated with sizes that are determined in proportion to the number of documents that belong to the clusters. That is, as the number of documents that belong to the cluster is larger, the area that is occupied by the cluster also becomes larger to heighten the intuitivity.

Further, since it is not possible to illustrate all the clusters on the cluster priority coordinate plane 110 at a time, the coordinate plane is configured in a manner that only the clusters having a predetermined size or more are illustrated thereon. Further, if a specific area is expanded, the cluster priority coordinate plane 110 may be configured in a manner that clusters having a small size, which are positioned on the corresponding specific area, can be seen. That is, the cluster priority coordinate plane may be a cluster distribution map having zoom-in and zoom-out functions. Accordingly, the cluster priority coordinate plane 110 may include an expansion/contraction bar 115 for performing the zoom-in and zoom-out functions. Once the specific area is expanded using the expansion/contraction bar, the clusters that belong to the corresponding area can be confirmed in more detail.

FIGS. 12 and 13 are exemplary diagrams of a graphic user interface for providing clusters and documents belonging to the clusters to a user using priorities of the clusters and priorities of the documents belonging to the clusters according to some embodiments of the present invention.

FIGS. 12 and 13 illustrate a general cluster providing screen in the form of a list and a screen that provides documents that belong to a cluster. In the cluster providing screen in the form of a list, clusters are aligned and provided using the priorities of the clusters obtained as above, subject words of the respective cluster are displayed, and summary information of the documents having the highest priority, which belong to the respective clusters can be provided together. Here, extraction of the summary information of the document having the highest priority may be performed using the text mining method. Further, in order to strengthen the user convenience, the kind and the number of documents that belong to the respective clusters and information on read/non-read documents can be provided together.

According to the example of FIG. 12, the cluster having the highest priority is a cluster having the subject of “Chinese HER market search”, and below this cluster, summary information of the document having the highest priority, such as “According to the IDC report, it is expected that the Chinese market size will reach $1.6 B in 2018, and 15.6% CAGR (Compound Annual Growth Rate), and about 400 local companies play a leading part in the market . . . ”, is provided together. Further, the corresponding cluster has three mail documents, 6 BBS (Bulletin Board System) documents, and 13 SNS (Social Network Service) documents. Among them, information on one unconfirmed mail document and two unconfirmed SNS documents can be confirmed.

If a user selects and reads a specific cluster in a cluster list, information on respective documents that belong to the selected cluster can be aligned and provided according to the priorities of the documents. Here, if the document is selected again, the screen is shifted to a reading screen of the corresponding document to provide the detailed contents of the document.

In the example of FIG. 13, the user selects the cluster having the subject of “Chinese HER market search”, which has priority 1, and information on the respective documents that belong to the corresponding cluster is provided to the user. Accordingly, the user can read and confirm the document more conveniently. In particular, if the priorities of the respective documents are visualized in star shapes, the user convenience can be further strengthened.

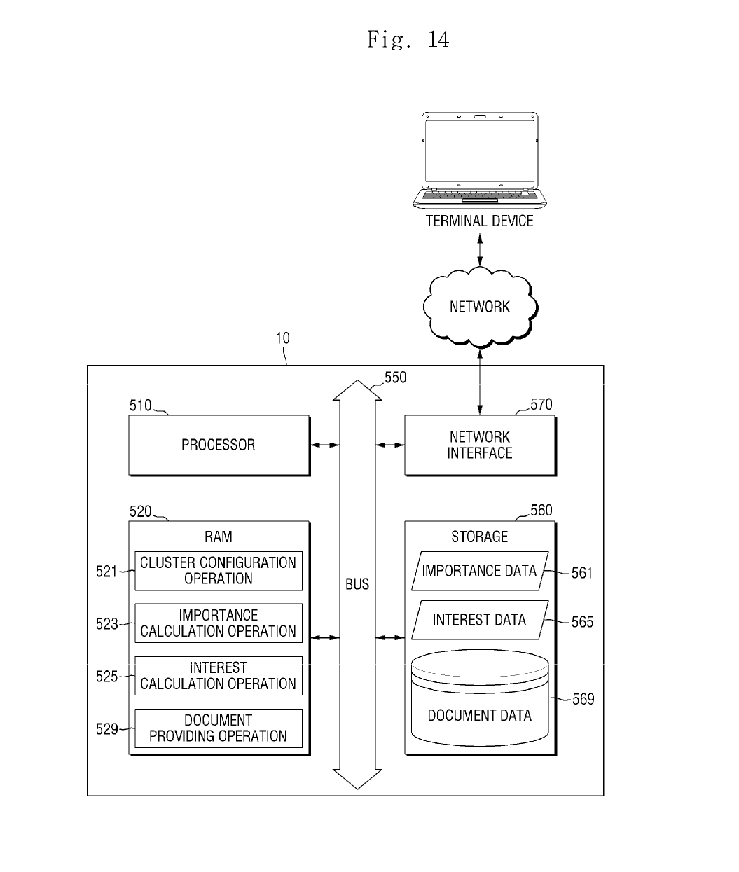

FIG. 14 is a diagram of a hardware configuration of an apparatus for providing documents reflecting a user pattern according to some embodiments of the present invention.

Referring to FIG. 14, an apparatus 10 for providing documents reflecting a user pattern may include at least one processor 510, a memory 520, a storage 560, and an interface. The processor 510, the memory 520, the storage 560, and the interface 570 transmit/receive data through a system bus 550.

The processor 510 executes a computer program that is loaded in the memory 520, and the memory 520 loads the computer program from the storage 560. The computer program may include a cluster configuration operation 521, an importance calculation operation 523, an interest calculation operation 525, and a document providing operation 529. The processor 510 may include a central processing unit (CPU), a microprocessor, or the like.

The cluster configuration operation 521 may load document data 569 that is stored in the storage 560 onto the memory 520 through the system bus 550. Further, the cluster configuration operation 521 may configure the cluster by clustering the plurality of documents based on document meta information, document contents information, and document priority information.

The importance calculation operation 523 may calculate the cluster importance through analysis of the cluster information. Further, the importance calculation operation 523 may calculate the document importance of the documents that belong to the cluster through analysis of the document information that belongs to the cluster. Further, the cluster importance data and document importance data that are configured in the memory 520 are stored as the importance data 561 of the storage 560 through the system bus 550.

The interest calculation operation 525 may calculate the user interest of the cluster through analysis of the user's use pattern for the cluster. Further, the interest calculation operation 525 may calculate the user interest of the documents that belong to the cluster through analysis of the user's use pattern for the documents that belong to the cluster. Further, the user interest data of the cluster and the user interest data of the documents that are configured in the memory 520 are stored as the interest data 565 of the storage 560 through the system bus 550.

The apparatus 10 for providing documents reflecting a user pattern provides an interface for reading and confirming video data 569, announcer data 561, and audience data 565 to the storage 560 through a network interface 570.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of providing documents based on a use pattern, the method comprising:
configuring a cluster by clustering a plurality of documents;
calculating a cluster importance of the cluster based on information of the cluster;
calculating a user interest of the cluster based on a use pattern of a user with respect to the cluster;
calculating a document importance of a respective document that belongs to the cluster based on information of the respective document;
calculating a user interest of the respective document that belongs to the cluster based on the use pattern of the user with respect to the respective document; and
providing the respective document using the cluster importance of the cluster, the user interest of the cluster, the document importance of the respective document, and the user interest of the respective document.

2. The method of claim 1, wherein the configuring the cluster comprises configuring the cluster based on at least one from among an entity that generates the plurality of documents, a date on which the plurality of documents are generated, whether the plurality of documents have been read, and whether the plurality of documents have an accompanying file.

3. The method of claim 1, wherein the configuring the cluster comprises:
calculating a similarity between the plurality of documents based on analysis of texts in the plurality of documents; and
configuring the cluster based on the calculated similarity.

4. The method of claim 1, wherein the configuring the cluster comprises obtaining a subject word of the cluster using a configuration standard, which is used to configure the cluster.

5. The method of claim 1, wherein the calculating the cluster importance of the cluster comprises calculating the cluster importance of the cluster based on at least one from among a date on which the cluster is configured, a number of documents that belong to the cluster, and a size of the documents that belong to the cluster.

6. The method of claim 1, wherein the calculating the user interest of the cluster comprises calculating the user interest of the cluster based on at least one from among a date on which the cluster is ready by the user, an accumulated frequency at which the cluster is read by the user, and an accumulated time in which the cluster is read by the user.

7. The method of claim 1, wherein the calculating the document importance of the respective document comprises calculating the document importance of the respective document based on at least one from among an entity that generates the respective document, a date on which the respective document is generated, a kind of the respective document, and a size of the respective document.

8. The method of claim 1, wherein the calculating the document importance of the respective document comprises calculating the document importance of the respective document based on a frequency of appearance of a keyword in a text of the respective document.

9. The method of claim 1, wherein the calculating the user interest of the respective document comprises calculating the user interest of the respective document based on at least one from among a date on which the respective document is ready by the user, an accumulated frequency at which the respective document is read, and an accumulated time in which the respective document is read.

10. The method of claim 1, wherein the calculating the user interest of the respective document comprises calculating the user interest of the respective document based on whether the respective document is read by the user.

11. The method of claim 1, wherein the providing the respective document comprises:
calculating a priority of the cluster using the cluster importance and the user interest of the cluster;
calculating a priority of the respective document using the document importance and the user interest of the respective document; and
providing the respective document based on the priority of the cluster and the priority of the respective document.

12. The method of claim 11, wherein the providing the respective document based on the priority of the cluster and the priority of the respective document comprises:
arranging and providing the cluster using the priority of the cluster; and
arranging and providing the respective document using the priority of the respective document.

13. The method of claim 11, wherein the providing the respective document further comprises providing summary information of a document having a highest priority among documents that belong to the cluster, together with the cluster.

14. The method of claim 1, wherein the providing the respective document comprises providing the respective document on a priority coordinate plane, the priority coordinate plane having a first axis that represents the cluster importance of the cluster to which the respective document belongs and a second axis that represents the user interest of the cluster to which the respective document belongs.

15. A method of providing documents based on a use pattern, the method comprising:
calculating a document importance of a respective document among a plurality of documents;
calculating a user interest of the respective document based on a use pattern of a user with respect to the respective document;
clustering the plurality of documents using the user importance and the user interest of the respective document and configuring a cluster according to a result of the clustering;
calculating a cluster importance of the cluster and a user interest of the cluster using the document importance and the user interest of a document that belongs to the cluster; and
providing the document that belongs to the cluster, using the cluster importance and the user interest of the cluster and the document importance and the user interest of the document.

16. The method of claim 15, wherein the providing the document comprises providing the document on a priority coordinate plane, the priority coordinate plane having a first axis that represents the cluster importance of the cluster to which the document belongs to and a second axis that represents the user interest of the cluster to which the document belongs.

17. An apparatus for providing documents based on a use pattern, the apparatus comprising:
at least one processor; and
a memory configured to load a computer program to be executed by the at least one processor,
wherein the computer program, when executed by the at least one processor, causes the at least one processor to:
configure a cluster by clustering of a plurality of documents;
calculate a cluster importance of the cluster based on an information of the cluster;
calculate a user interest of the cluster based on a use pattern of a user with respect to the cluster;
calculate a document importance of a respective document that belongs to the cluster based on information of the respective document;
calculate a user interest of the respective document that belongs to the cluster based on the use pattern of the user with respect to the respective document; and
provide the respective document using the cluster importance of the cluster, the user interest of the cluster, the document importance of the respective document, and the user interest of the respective document.
